(19) United States
(12) Patent Application Publication
(10) Pub. No.: US 2014/0093121 A1
(43) Pub. Date: Apr. 3, 2014

(54) IMAGE PROCESSING APPARATUS AND METHOD

(71) Applicant: FUJITSU LIMITED, Kawasaki-shi (JP)

(72) Inventor: Taizo ANAN, Kawasaki (JP)

(73) Assignee: FUJITSU LIMITED, Kawasaki-shi (JP)

(21) Appl. No.: 14/035,251

(22) Filed: Sep. 24, 2013

(30) Foreign Application Priority Data
Oct. 1, 2012 (JP) 2012-219535

(51) Int. Cl. G06T 1/00

(52) U.S. Cl. CPC G06T 1/005
USPC 382/100

(57) ABSTRACT

An image processing apparatus includes a processor that executes a procedure. The procedure includes: applying distortion processing to each frame of the whole of or a section of video image data that contains plural successive frames and that is provided to plural users, the distortion processing being selected from amongst plural types of distortion processing such that a different distortion processing is applied for each of the users.

### CROSS-REFERENCE TO RELATED APPLICATION

This application is based upon and claims the benefit of priority of the prior Japanese Patent Application No. 2012-219535, filed on Oct. 1, 2012, the entire content of which is incorporated herein by reference.

### FIELD

The embodiments discussed herein are related to an image processing apparatus and image processing method.

### BACKGROUND

Recently services are being provided that distribute picture content such as films through for example the internet. Such picture content is distributed after encrypting using Digital Rights Management (DRM) technology. The DRM technology places limitations on un-authorized copying or distribution of the picture content.

Moreover, technology is being developed in which data such as an ID number of a viewer is embedded in advance as a digital watermark into video image data configuring picture content. For example, sometimes video image data is copied without authorization by capturing a picture based on video image data that is displayed on a display using a camcorder, in what is referred to as analogue capture. However, the digital watermark remains as before in the video image data copied by analogue capture of the picture based on the video image data embedded with the digital watermark. It is accordingly possible to identify data such as the ID number of the viewer embedded as a digital watermark in the video image data by detecting the digital watermark in the copied video image data even after distribution of such unauthorized copies of video image data captured by analogue capture. Even when picture content is copied without authorization and uploaded to for example video sharing sites, the rights manager of the picture content is accordingly able to identify the distribution source from the data embedded in the video image data configuring the uploaded picture content.

In order to avoid identification, an unauthorized user plotting to distribute picture content without authorization performs attacks to destroy a digital watermark by capturing a TV screen with a camcorder, and by various operations such as by re-compressing, adding noise and rotating. However, the technology of current digital watermarks is designed to resist the majority of attacks. Among these, one of the most effective techniques for destroying a digital watermark embedded in picture content is a technique called collusion attack. Examples of collusion attacks are illustrated in FIG. 12 and FIG. 13. In the example of a collusion attack illustrated in FIG. 12, plural users attempting to perform a collusion attack (colluder 1 and colluder 2 in FIG. 12) hold picture content respectively embedded with the ID number of each user. Frames are then extracted at random from the picture content of each of the colluders and compiled together (random frame selection). In the example of a collusion attack illustrated in FIG. 13, average values are calculated of the pixel values for each frame of picture content embedded with the user-specific user ID number (averaging). Picture content is thereby generated by such collusion attacks in which the pre-embedded digital watermark has been destroyed.

As counter measures to such collusion attacks, technology is proposed in which special code called collusion attack-secure code is employed, and collusion attacker identification data is extracted from collusion attacked picture content. However, in collusion attack-secure code, in order to embed 1 bit of data, there is a need to embed several times that amount of code. The amount of data that can be embedded in short picture content such as music videos is accordingly extremely small. There is also technology proposed that employs a short code to address such issues with collusion attack-secure code.

### RELATED PATENT DOCUMENTS

D. Boneh and J. Shaw, “Collusion-Secure Fingerprinting for Digital Data”, IEEE TRANSACTIONS ON INFORMATION THEORY, VOL. 44, NO. 5, SEPTEMBER 1998, pp. 1897-1905.
Tarodos, G, “Optimal Probabilistic Fingerprinting Codes”, STOC '03, ACM(2003), pp. 116-125.
Muratani, H. “A Collusion-Secure Fingerprinting Code Reduced by Chinese Remaindering and Its Random-Error Resilience”, IH 2001, LNCS 2137 (2001) pp. 303-315.
Tri Van Le, Mike Burmester and Jiangyi Hu, “Short c-secure Fingerprinting Codes”, Proc. of the 6th ISC '03, (2003), pp. 422-428.

### SUMMARY

According to an aspect of the embodiments, an image processing apparatus includes: a processor; and a memory storing instructions, which, when executed by the processor, perform a procedure, the procedure including: (a) applying distortion processing to each frame of the whole of or a section of video image data that contains plural successive frames and that is provided to plural users, the distortion processing being selected from amongst plural types of distortion processing such that a different distortion processing is applied for each of the users.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a functional block diagram illustrating an example of an image processing apparatus according to a first exemplary embodiment;

FIG. 2 is an illustration to explain mapping transformation as an example of distortion processing;

FIG. 3 is a schematic block diagram illustrating an example of a computer that functions as an image processing apparatus;

FIG. 4 is a flow chart illustrating image processing in the first exemplary embodiment;

FIG. 5 is an illustration to explain advantageous effects of the first exemplary embodiment;

FIG. 6 is a functional block diagram to illustrate an example of an image processing apparatus according to a second exemplary embodiment;

FIG. 7 is a flow chart illustrating image processing in the second exemplary embodiment;

FIG. 8 is a functional block diagram illustrating an example of an image processing apparatus according to a third exemplary embodiment;

FIG. 9 is an illustration to explain an example of a movement region detection method;

FIG. 10 is a flow chart illustrating image processing in the third exemplary embodiment;

FIG. 11 is an illustration to explain an example of image processing in the third exemplary embodiment;

FIG. 12 is an illustration to explain an example of collusion attack; and

FIG. 13 is an illustration to explain an example of collusion attack.

### DESCRIPTION OF EMBODIMENTS

Detailed explanation follows regarding an example of an exemplary embodiment of technology disclosed herein, with reference to the drawings.

### First Exemplary Embodiment

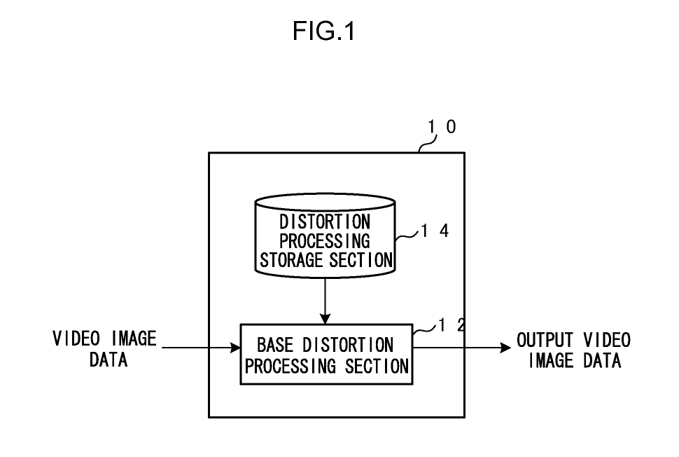

FIG. 1 illustrates an image processing apparatus 10 according to a first exemplary embodiment. The image processing apparatus 10 is an apparatus that applies a minute amount of distortion in advance to picture content for each viewer when a viewer is viewing picture content. By applying a minute amount of distortion to picture content, the image processing apparatus 10 causes the quality of picture content generated by a collusion attack to deteriorate when a collusion attack on the picture content is carried out by multiple viewers to destroy a digital watermark. The image processing apparatus 10 includes a base distortion processing section 12 and a distortion processing storage section 14.

The image processing apparatus 10 receives input as video image data. The video image data contains plural successive frames. A user ID is embedded as a digital watermark in the video image data. A digital watermark may be embedded in video image data by, for example, changing pixel values of each frame within a range not noticeable by a user. A user ID is one example of data for identifying to whom the picture content was provided, and other data may also be embedded as a digital watermark. Data other than data for identifying to whom the picture content was provided (such as for example copy-write data) may be combined and embedded as a digital watermark.

The base distortion processing section 12 selects one type of distortion processing according to user ID from plural types of distortion processing stored in the distortion processing storage section 14, as described later. Selection of distortion processing is made such that a different type of distortion processing is selected according to the user ID. For example, configuration may be made such that consecutive numbers are allocated to the respective plural types of distortion processing stored in the distortion processing storage section 14, a pseudorandom number is generated using the user ID as a seed, and then distortion processing of the number corresponding to the generated pseudorandom number is selected. Then the base distortion processing section 12 applies the selected distortion processing to each of the frames of the received video image data. The frames to which distortion processing is applied by the base distortion processing section 12 may be all frames of the video image data, or may be only some of the frames. However an example is explained here in which the distortion processing is applied to all frames.

The distortion processing stored in the distortion processing storage section 14 is preferably processing wherein distortion in the picture itself displayed based on the video image data is difficult for a viewer to discern even when the distortion processing is applied to each of the frames of the video image data. One of the following geometric transformations may, for example, be applied as the distortion processing.

1. The image of each of the frames is enlarged by a few percent, and the region that projects out from the frame size is cut off.

2. The image of each of the frames is enlarged by a few percent and then shifted by several pixels, and the region that projects out from the frame size is cut off.

3. Two dimensional or three dimensional rotation is performed about a given pixel inside the image of each of the frames, and the region that projects out from the frame size is cut off. Note that rotation in three dimensions refers to a geometric transformation that deforms an image by rotating not only in the horizontal direction and vertical direction of the image, but also simulating rotation in the depth direction.

The following signal processing may also be applied as the distortion processing.

4. Raising or lowering pixel values (at least one out of brightness (luminance), hue and saturation) of pixels of each of the frames.

5. Changing the pixel values so as to raise or lower the distribution of pixel values of pixels of each of the frames.

6. Adding noise to the image of each of the frames.

Explanation follows regarding more specific examples of distortion processing. For example, an affine transformation as represented by the following Equation (1) may be employed as a geometric transformation.

$$\{ \begin{matrix}x = {ax}^{′} + {by}^{′} + e \\ y = {cx}^{′} + {dy}^{′} + f\end{matrix} \qquad ( 1 )$$

Wherein: x, y are coordinates of pixels in each frame after transformation, x′, y′ are coordinates prior to transformation, and a, b, c, d, e and f are transformation parameters. Pincushion distortion or barrel distortion such as that represented by the following Equation (2) may also be applied as another example of a transformation method. In Equation (2), for example, pincushion distortion occurs when k₁=1, k₂=−0.01, and barrel distortion occurs when k₁=1, k₂=0.01.

$$\{ \begin{matrix}x = {k}_{1} {x}^{′} ( 1 + {k}_{2} ( {x}^{′2} + {y}^{′2} ) ) \\ y = {k}_{1} {y}^{′} ( 1 + {k}_{2} ( {x}^{′2} + {y}^{′2} ) )\end{matrix} \qquad ( 2 )$$

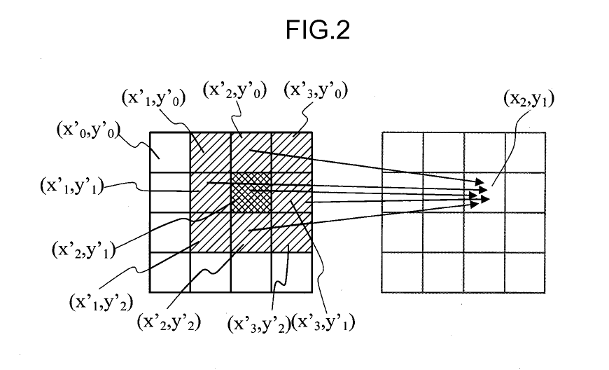

Moreover, mapping transformation may also be applied as represented by the following Equation (3). As illustrated in FIG. 2, in the mapping transformation expressed by Equation (3) all coordinates prior to transformation are weighted according to neighboring pixels indicating the destination to which shifting is made after transformation.

$$\{ \begin{matrix}( {x}_{0} , {y}_{0} ) = ( {\sum }_{k ∈ neighbor} {a}_{0}^{k} {x}_{0 - k}^{′} , {\sum }_{k ∈ neighbor} {b}_{0}^{k} {y}_{0 - k}^{′} ) \\ ( {x}_{1} , {y}_{0} ) = ( {\sum }_{k ∈ neighbor} {a}_{1}^{k} {x}_{i - k}^{′} , {\sum }_{k ∈ neighbor} {b}_{0}^{k} {y}_{0 - k}^{′} ) \\ ⋮ \\ ( {x}_{M - 1} , {y}_{N - 1} ) = ( {\sum }_{k ∈ neighbor} {a}_{M - 1}^{k} {x}_{N - 1 - k}^{′} , {\sum }_{k ∈ neighbor} {b}_{M - 1}^{k} {y}_{N - 1 - k}^{′} )\end{matrix} \qquad ( 3 )$$

Wherein neighbor expresses a collection of a pixel in question (xₘ,yₙ) (m=0, 1, and so on up to M−1, n=0, 1 and so on up to N−1), and neighboring pixels to the pixel in question (xₘ₋ₖ, yₙ₋ₖ). In the example of FIG. 2, the 8 pixels adjacent to the pixel in question (x′₂, y′₁) are denoted as neighboring pixels ((x′₁, y′₀), (x′₂, y′₀), (x′₃, y′₀), (x′₁, y′₁), (x′₃, y′₁), (x′₁, y′₂), (x′₂, y′₂), (x′₃, y′₂). k indicates the position in the x direction and the y direction of the neighboring pixels with respect to the pixel in question, and k=−1, 0, +1 when there are 8 pixels adjacent to the pixel in question as neighboring pixels. When the pixel in question is at (0, 0), then the neighbors are given by the following Equation (4).

neighbor={(0,0),(1,−1),(1,0),(1,1),(−1,−1),(−1,0),(−1,1),(0,−1),(0,1)} (4)

a^{k}ₘ, b^{k}ₙ are coefficients used when computing coordinates after transformation by respectively adding together the x coordinates and the y coordinates of the pixel in question and neighboring pixels. For example, coefficient a⁻¹ₘ is set large when it is desired to move the coordinates after transformation further to the left hand side in the frame than the original coordinates, and coefficient a⁺¹ₘ is set large when it is desired to move further to the right hand side. Moreover, the coefficient b⁻¹ₘ is set large when it is desired to move the coordinates after transformation further to the top in the frame than the original coordinates, and the coefficient b⁺¹₊ is set large when it is desired to move further to the bottom. Moreover, when it is desired not to move the coordinates after transformation, the akin and the bkn are set equal to each other, or set such that a⁰ₘ=b⁰ₙ=1 and other coefficients are set to 0. It is possible to perform various types of distortion processing by having plural sets of coefficient a^{k}ₘ, b^{k}ₙ, and k.

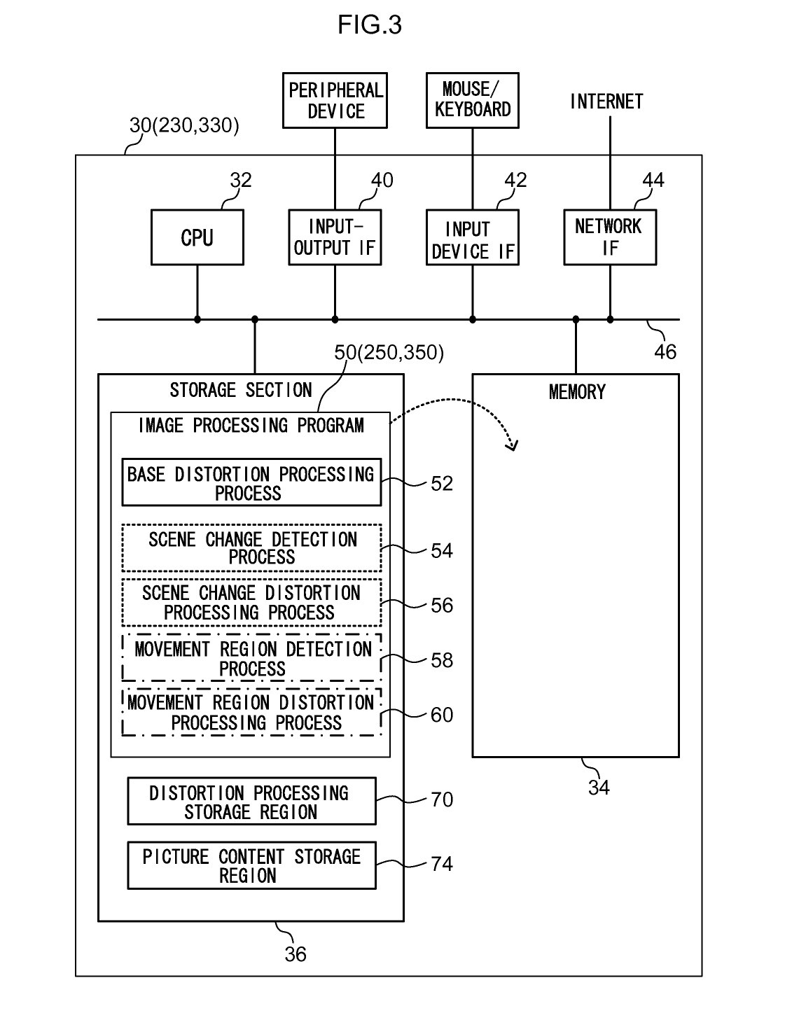

The image processing apparatus 10 may be implemented, for example, by a computer 30 as illustrated in FIG. 3. The computer 30 includes a CPU 32, a memory 34, a non-volatile storage section 36, an input-output interface (IF) 40, an input device IF 42, and a network IF 44. The CPU 32, the memory 34, the storage section 36, the input-output IF 40, the input device IF 42 and the network IF 44 are connected together through a bus 46.

The computer 30 is connected to peripheral devices through the input-output IF 40. The computer 30 is connected to input devices such as a mouse or keyboard through the input device IF 42. The computer 30 is connected to the Internet through the network IF 44.

Moreover, the storage section 36 may be implemented by for example a Hard Disk Drive (HDD) or flash memory. The storage section 36 serving as a storage medium stores an image processing program 50 that causes the computer 30 to function as the image processing apparatus 10. The storage section 36 is provided with a distortion processing storage region 70 stored with plural types of distortion processing, and a picture content storage region 74 for storing received picture content. The CPU 32 reads the image processing program 50 from the storage section 36 and expands it in the memory 34, and sequentially executes the processes of the image processing program 50.

The image processing program 50 includes a base distortion processing process 52. The CPU 32 operates as the base distortion processing section 12 illustrated in FIG. 1 by executing the base distortion processing process 52. The distortion processing storage region 70 functions as the distortion processing storage section 14 illustrated in FIG. 1 when the image processing apparatus 10 is implemented by the computer 30. The computer 30 executing the image processing program 50 accordingly functions as the image processing apparatus 10.

Note that it is possible to implement the image processing apparatus 10 by for example a semiconductor integrated circuit, and more particularly by an Application Specific Integrated Circuit (ASIC).

Explanation follows regarding operation of the first exemplary embodiment. On input of picture content to the image processing apparatus 10 through the input-output IF 40 and the network IF 44, in the image processing apparatus 10 the CPU 32 stores the input picture content in the picture content storage region 74. The picture content input in this case is embedded as a digital watermark with data indicating a user ID of the user to which the picture content was provided.

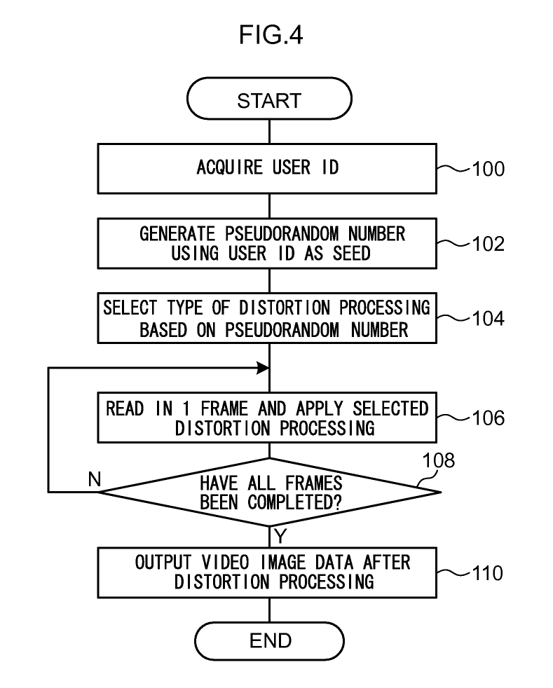

The CPU 32 expands the video image data containing plural successive frames configuring the picture content stored in the picture content storage region 74 frame-by-frame into the memory 34. The CPU 32 then executes the image processing illustrated in FIG. 4 by expanding the image processing program 50 stored in the storage section 36 into the memory 34.

At step 100 of the image processing illustrated in FIG. 4, the base distortion processing section 12 acquires the user ID. The user ID may be acquired by being input through the input-output IF 40, the input device IF 42 and the network IF 44, or may be pre-stored and acquired by reading in from a specific storage region of the storage section 36. The user ID may also be acquired by deciphering the digital watermark embedded in the video image data.

At the next step 102, the base distortion processing section 12 generates a pseudorandom number employing the acquired user ID as a seed.

At the next step 104, the base distortion processing section 12 selects 1 type of distortion processing from the plural types of distortion processing stored in the distortion processing storage section 14, based on the generated pseudorandom number.

At the next step 106, the base distortion processing section 12 reads in 1 frame of the video image data and applies the selected distortion processing to the image of the read frame.

At the next step 108, the base distortion processing section 12 determines whether or not the distortion processing has been applied to all the frames of the video image data. Processing returns to step 106 when there are still un-processed frames present, and the next frame is read and distortion processing applied thereto. Processing proceeds to step 110 when the distortion processing has been completed for all the frames, and the video image data to which the distortion processing has been applied is then output, thereby completing image processing.

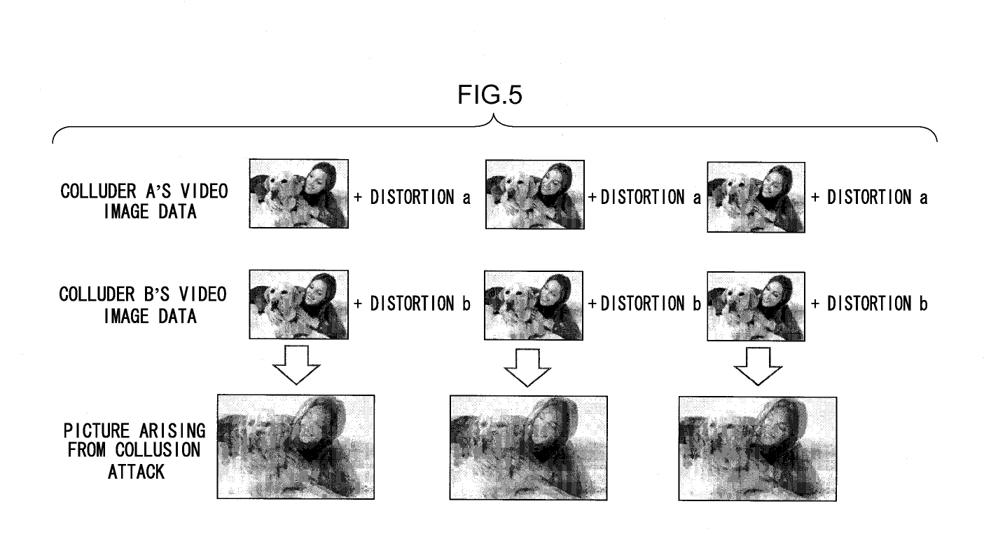

As explained above, according to the image processing apparatus 10 of the first exemplary embodiment, the distortion processing employed is difficult to notice in isolation from the distortion of a picture to which a single type of distortion processing has been applied, and a different type of distortion processing is selected for each user, who is the person to whom the picture content has been provided. The selected distortion processing is then applied to the video image data. This thus enables the picture quality created by a collusion attack to be deteriorated. For example, as illustrated in FIG. 5, a distortion a is applied to video image data for a collusion attacker A, and a distortion b, different to the distortion a, is applied to the video image data for a collusion attacker B. The collusion attacker A and the collusion attacker B collude with each other and perform a collusion attack such as by averaging, or random frame selection from, the video image data of the two parties. The resulting picture generated by such a collusion attack is a picture with no value due to being difficult to watch due to blurring or shaking. As a result, it is possible to suppress unauthorized distribution of picture content generated by collusion attack.

In general digital watermarks embedded in picture content are more easily destroyed the greater the number of collusion attackers. However, according to the image processing apparatus 10 of the present exemplary embodiment, since the number of types of distortion processing applied also increases as the number of collusion attackers increases, the picture quality generated by collusion attack is also deteriorated to a greater extent. Unauthorized distribution of picture content is accordingly effectively suppressed.

### Second Exemplary Embodiment

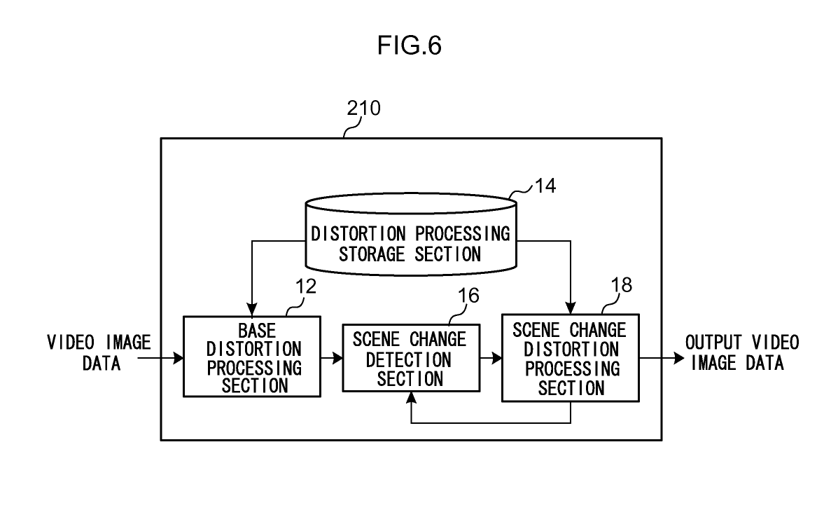

Explanation now follows regarding a second exemplary embodiment of the technology disclosed herein. FIG. 6 illustrates an image processing apparatus 210 according to the second exemplary embodiment. Note that parts of the second exemplary embodiment similar to those of the first exemplary embodiment are appended with the same reference numerals, and detailed explanation thereof is omitted. The image processing apparatus 210 includes a base distortion processing section 12, a distortion processing storage section 14, a scene change detection section 16 and a scene change distortion processing section 18.

The scene change detection section 16 detects for scene changes in the video image data. Detection for scene changes may be performed by determining places where an image feature amount based on pixel values of each of the frames changes by a predetermined inter-frame threshold value or greater. For example, a difference in pixel value of each of the pixels may be computed between each of the frames of the video image data, the absolute value of this difference taken, and scene changes detected by determining whether or not the sum of the difference absolute values for all the pixels exceeds a threshold value.

The scene change distortion processing section 18 selects, at each scene change detected by the scene change detection section 16, a different type of distortion processing to the distortion processing applied to the frames prior to the scene change from out of plural types of distortion processing stored in the distortion processing storage section 14. The distortion processing selected for each scene change is also selected such that a different type of distortion processing is selected for each user for the same block of video image data (between one scene change and the next scene change).

The scene change distortion processing section 18 then applies the changed distortion processing to the frames subsequent to the scene change. There are 2 reasons why the distortion processing is changed in this manner at each scene change. The first reason is that it is difficult for a viewer to ascertain a change in distortion processing at scene change timings, thereby enabling prevention of a user being imparted with an unnatural sensation. The second reason is that since plural types of distortion processing can be applied to the received video image data as a whole, this enables a picture generated by collusion attack to be deteriorated in a complex manner. For example, consider a case in which there are M types of distortion processing stored in the distortion processing storage section 14, with the scene changing L times in the video image data. In such cases, with 1 type of distortion processing applied by the base distortion processing section 12, and with L types applied by the scene change distortion processing section 18, this enables ML+1 combinations of types of distortion processing to be implemented. Making the combinations of distortion processing more complicated enables a collusion attack that attempts to analyze the distortion processing applied to the video image data to be thwarted.

The image processing apparatus 210, similarly to in the first exemplary embodiment, may, for example, be implemented by a computer 230 as illustrated in FIG. 3. The storage section 36 serving as the storage medium is stored with an image processing program 250 that causes the computer 230 to function as the image processing apparatus 210. The CPU 32 reads the image processing program 250 from the storage section 36 and expands it in the memory 34, and sequentially executes the processes of the image processing program 250.

The image processing program 250 includes a base distortion processing process 52, a scene change detection process 54 and a scene change distortion processing process 56. The CPU 32 operates as the base distortion processing section 12 illustrated in FIG. 6 by executing the base distortion processing process 52. The CPU 32 operates as the scene change detection section 16 illustrated in FIG. 6 by executing the scene change detection process 54. The CPU 32 operates as the scene change distortion processing section 18 illustrated in FIG. 6 by executing the scene change distortion processing process 56. On implementation of the image processing apparatus 210 by the computer 230, the distortion processing storage region 70 functions as the distortion processing storage section 14 illustrated in FIG. 6. The computer 230 executing the image processing program 250 accordingly functions as the image processing apparatus 210.

Note that it is possible to implement the image processing apparatus 210 with, for example, a semiconductor integrated circuit, and more particularly with for example an ASIC.

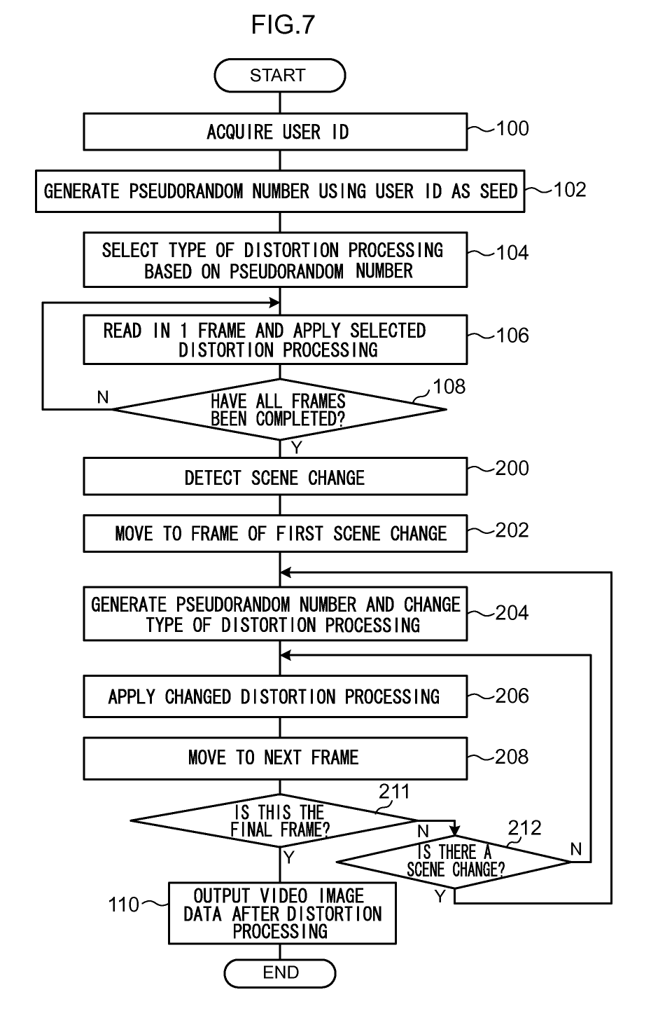

Explanation next follows regarding parts of the operation of the second exemplary embodiment that differ from those of the first exemplary embodiment. In the second exemplary embodiment, the image processing illustrated in FIG. 7 is executed in the image processing apparatus 210.

The base distortion processing section 12 applies the distortion processing selected at step 104 to all frames of the video image data through the processing of steps 100 to 108 of the image processing illustrated in FIG. 7.

Then, at step 200, the scene change detection section 16 detects for scene changes by, for example, computing the difference between the pixel values of each of the pixels between each of the frames of the video image data, taking difference absolute values thereof, and determining whether or not the sum of the difference absolute values for all the pixels exceeds a threshold value. The scene change detection section 16 appends a flag indicating scene change to a frame immediately following a detected scene change. The scene change detection section 16 detects for all of the scene changes in the video image data.

Next at step 202, based on the flags appended at step 200, the scene change detection section 16 transitions the frame subject to processing to the frame at the first scene change in the video image data.

Next at step 204, the scene change distortion processing section 18 generates a pseudorandom number using the user ID as the seed. Setting is made such that a different pseudorandom number is generated to the pseudorandom number generated at step 102. The scene change distortion processing section 18 then, based on the generated pseudorandom number, selects 1 type of distortion processing from amongst the plural types of distortion processing stored in the distortion processing storage section 14. Due to distortion processing selection being based on a different pseudorandom number to the pseudorandom number generated at step 102, distortion processing is changed to different distortion processing to that applied to the frames prior to the scene change.

Then at step 206 the scene change distortion processing section 18 applies the distortion processing that was changed at step 204 to the frame subject to processing.

Next at step 208 the scene change distortion processing section 18 transitions the frame subject to processing to the next frame.

Next at step 211 the scene change distortion processing section 18 determines whether or not the frame subject to processing is the last frame. When it is not the last frame, processing proceeds to step 212 and the scene change detection section 16 determines whether or not the frame subject to processing is the next scene change by determining whether or not there is a flag appended to the frame subject to processing. Processing returns to step 206 when the frame subject to processing is not a scene change, and the scene change distortion processing section 18 applies the same type of distortion processing to the processing frame subject as the distortion processing that was applied to the one-previous frame. However processing returns to step 204 when there is a scene change, and the scene change distortion processing section 18 changes the type of distortion processing by generating a pseudorandom number that is different to the pseudorandom number generated at step 204 the previous time. Processing of steps 206 to 212 is repeated.

Processing proceeds to step 110 when determined by the scene change distortion processing section 18 at step 211 that the frame subject to processing is the last frame, and the video image data to which the distortion processing has been applied is then output, thereby completing the image processing.

As explained above, according to the image processing apparatus 210 of the second exemplary embodiment, due to changing the type of distortion processing at each scene change, it is possible to deteriorate the picture quality generated by collusion attack in a more complex manner without imparting an unnatural sensation to the normal viewer.

Note that in the second exemplary embodiment, explanation has been given of a case in which the type of distortion processing is changed for every scene change detected in the video image data, however configuration may be made such that the type of distortion processing is changed for every specific number of scene changes selected from the detected scene changes.

Moreover, in the second exemplary embodiment, although explanation has been given of a case in which scene change is detected after first performing distortion processing to every frame with the base distortion processing section, configuration may be made such that the scene changes are detected first. In such cases distortion processing may be applied by the base distortion processing section to each frame from the top frame to the first scene change. Then from after the first scene change, the type of distortion processing may be changed at each scene change using the scene change detection section and the scene change distortion processing section.

Moreover, in the second exemplary embodiment, although explanation has been given of a case in which the distortion processing applied to frames after a scene change is changed, any approach may be adopted in which the distortion processing is changed so as to differ between the frames prior to a scene change and the frames after a scene change. For example, configuration may be made such that, after all of the scene changes in the video image data have been detected, working backwards from the last frame, at each of the scene changes a different type of distortion processing is applied to frames prior to the scene change to the distortion processing applied to frames after the scene change.

Moreover, changing the distortion processing in the second exemplary embodiment may be performed by switching over the distortion processing that is applied to each of the frames of the original video image data, or may be performed by further applying a selected new distortion processing to apply in addition to the distortion processing executed up to the previous frame.

### Third Exemplary Embodiment

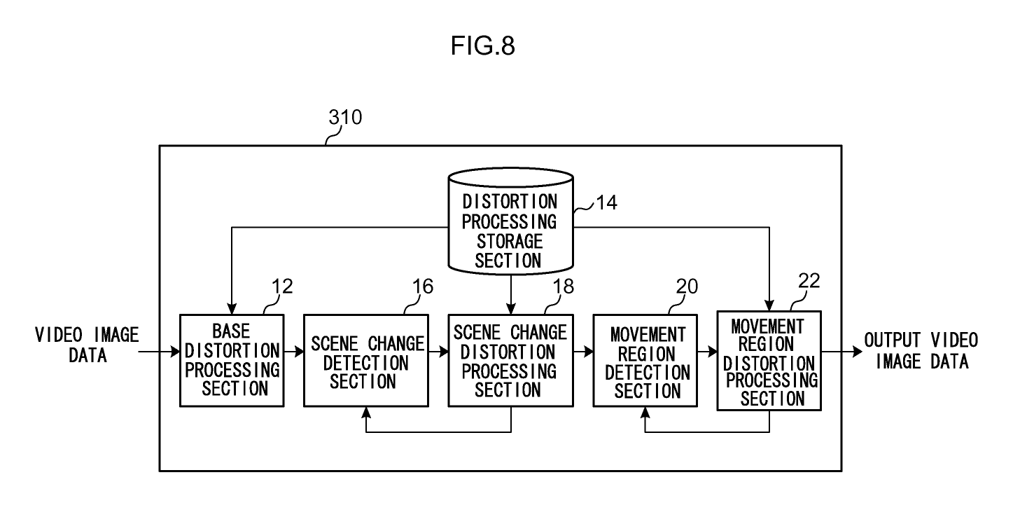

Explanation follows regarding a third exemplary embodiment of technology disclosed herein. FIG. 8 illustrates an image processing apparatus 310 according to the third exemplary embodiment. Note that the same reference numerals are appended to parts of the third exemplary embodiment similar to those of the first and second exemplary embodiments, and detailed explanation thereof is omitted. The image processing apparatus 310 includes a base distortion processing section 12, a distortion processing storage section 14, a scene change detection section 16, a scene change distortion processing section 18, a movement region detection section 20 and a movement region distortion processing section 22.

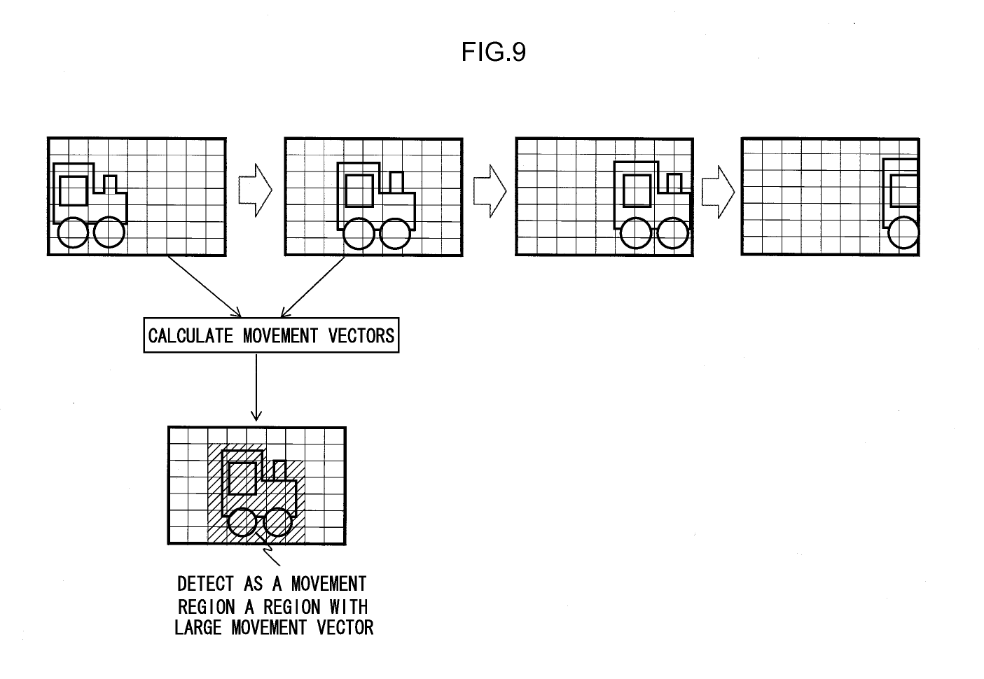

The movement region detection section 20 detects for a region (movement region) where a moving object is present in part of the video image data in cases in which there is not a great change in the screen as a whole, such as in a scene change. Detection of the movement region may for example be performed by, as illustrated in FIG. 9, calculating movement vectors between successive frames, and detecting as movement regions any region where the movement vectors are a threshold value or greater.

The movement region distortion processing section 22 then selects, from plural types of distortion processing stored in the distortion processing storage section 14, a distortion processing that is different type of distortion processing to the distortion processing applied to the frame as a whole. The movement region distortion processing section 22 then applies the selected distortion processing to the movement region detected using the movement region detection section 20. Thus even though distortion processing is applied to the movement region, since the fact that distortion processing has been applied is difficult to discern with the naked eye, a more complicated manner of deterioration of pictures generated by collusion attack is enabled without imparting an unnatural sensation to a viewer.

For example, consider a case in which there are M types of distortion processing stored in the distortion processing storage section 14, with the scene changing L times in the video image data, and K times of movement region detection. In such cases, combining 1 type of distortion processing applied by the base distortion processing section 12, with L types applied by the scene change distortion processing section 18, and with K types applied by the movement region distortion processing section 22, enables ML+1+K combinations of distortion processing to be implemented. Note that the movement region detection times K is a number of times from counting up the number of detection times, wherein 1 movement region detection occasion is counted for each continuous period in which a movement region is detected, by counting up when a movement region is detected again after a movement region has ceased to be detected.

The image processing apparatus 310 may, similarly to in the first exemplary embodiment, be implemented by for example a computer 330 as illustrated in FIG. 3. A storage section 36 serving as a storage medium is stored with an image processing program 350 that causes the computer 330 to function as the image processing apparatus 310. A CPU 32 reads the image processing program 350 from the storage section 36 and expands it into the memory 34, then sequentially executes the processes of the image processing program 350.

The image processing program 350 includes a base distortion processing process 52, a scene change detection process 54, a scene change distortion processing process 56, a movement region detection process 58, and a movement region distortion processing process 60. The CPU 32 operates as the base distortion processing section 12 illustrated in FIG. 8 by executing the base distortion processing process 52. The CPU 32 operates as the scene change detection section 16 illustrated in FIG. 8 by executing the scene change detection process 54. The CPU 32 operates as the scene change distortion processing section 18 illustrated in FIG. 8 by executing the scene change distortion processing process 56. The CPU 32 operates as the movement region detection section 20 illustrated in FIG. 8 by executing the movement region detection process 58. The CPU 32 operates as the movement region distortion processing section 22 illustrated in FIG. 8 by executing the movement region distortion processing process 60. Thus, on implementation of the image processing apparatus 310 by the computer 330, the distortion processing storage region 70 functions as the distortion processing storage section 14 illustrated in FIG. 8. The computer 330 executing the image processing program 350 accordingly functions as the image processing apparatus 310.

Note that it is possible to implement the image processing apparatus 310 with, for example, a semiconductor integrated circuit, and more particularly by for example an ASIC.

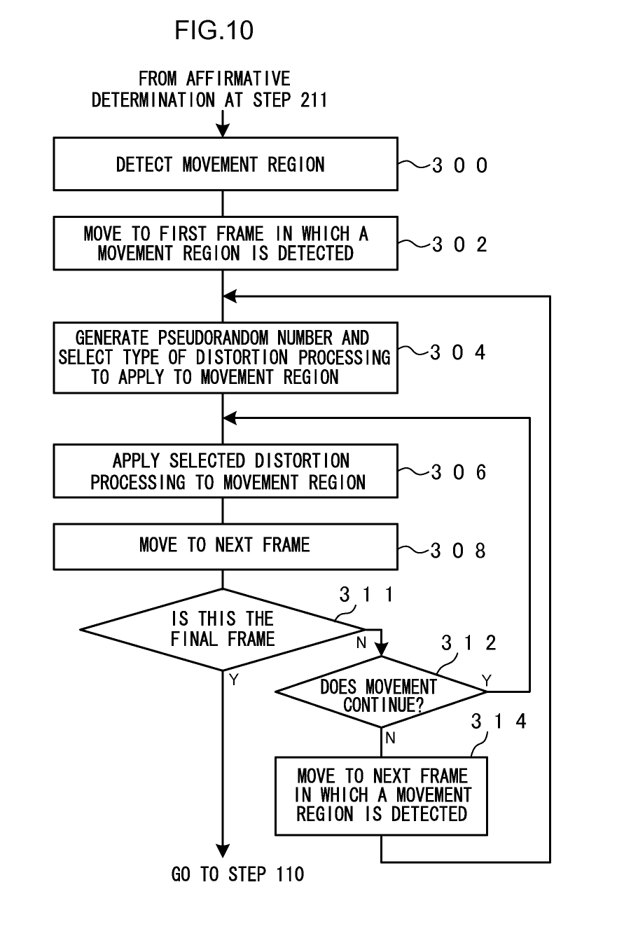

Explanation next follows regarding parts of the operation of the third exemplary embodiment that differ from those of the first and second exemplary embodiments. In the image processing apparatus 310 of the third exemplary embodiment, additional image processing of the processing illustrated in FIG. 10 is executed between step 211 and step 110 of the image processing of the second exemplary embodiment (FIG. 7).

By executing the image processing of the second exemplary embodiment, the image processing apparatus 310 is input with the video image data to which the base distortion processing is applied to the video image data as a whole and in which the distortion processing changes at each scene change, and processing proceeds to step 300.

At step 300, the movement region detection section 20 calculates movement vectors between successive frames, and detects regions in which the movement vectors are a threshold value or greater as movement regions. The movement region detection section 20 appends a flag indicating that there is a movement region present to frames in which a movement region is detected, and records the position of the movement region. The movement region detection section 20 detects whether or not a movement region is present for all the frames in the video image data.

Next at step 302, based on the flags applied at step 300, the movement region detection section 20 transitions the frame subject to processing to the first frame in which a movement region is detected in the video image data.

Next at step 304, the movement region distortion processing section 22 generates a pseudorandom number using the user ID as the seed. Setting is made such that a pseudorandom number is generated that differs from the pseudorandom number generated at step 102 and step 204. The movement region distortion processing section 22 then selects, from amongst the plural types of distortion processing stored in the distortion processing storage section 14, 1 type of distortion processing based on the generated pseudorandom number.

Next at step 306, the movement region distortion processing section 22 applies the distortion processing selected at step 304 to the movement region in the frame subject to processing. The distortion processing applied here is selected based on a pseudorandom number different form the pseudorandom numbers generated at step 102 and step 204, and hence different distortion processing is applied to the distortion processing that was applied to the frame as a whole.

Next at step 308, the movement region distortion processing section 22 transitions the frame subject to processing to the next frame.

Next at step 311, the movement region distortion processing section 22 determines whether or not the frame subject to processing is the last frame. Processing proceeds to step 312 when not the last frame, and the movement region detection section 20 determines whether or not movement continues by determining whether or not a flag is appended to the frame subject to processing. Processing returns to step 306 when movement continues, and the movement region distortion processing section 22 applies to the movement region inside the frame subject to processing distortion processing that is the same distortion processing as the distortion processing applied to the movement region in the previous frame. However processing proceeds to step 314 when movement does not continue, namely when there is no movement region within the frame subject to processing.

At step 314, based on the flags appended at step 300, the movement region detection section 20 transitions the frame subject to processing to the next frame in which a movement region is detected in the video image data. Processing then returns to step 304, and the movement region distortion processing section 22 changes the type of distortion processing applied to the movement region by generating a pseudorandom number that is different from the pseudorandom number generated at step 304 the previous time, and the processing of steps 306 to 314 is repeated.

The movement region distortion processing section 22 proceeds to step 110 when determined at step 311 that frame subject to processing is the last frame, the video data to which distortion processing has been applied is output, thereby completing image processing.

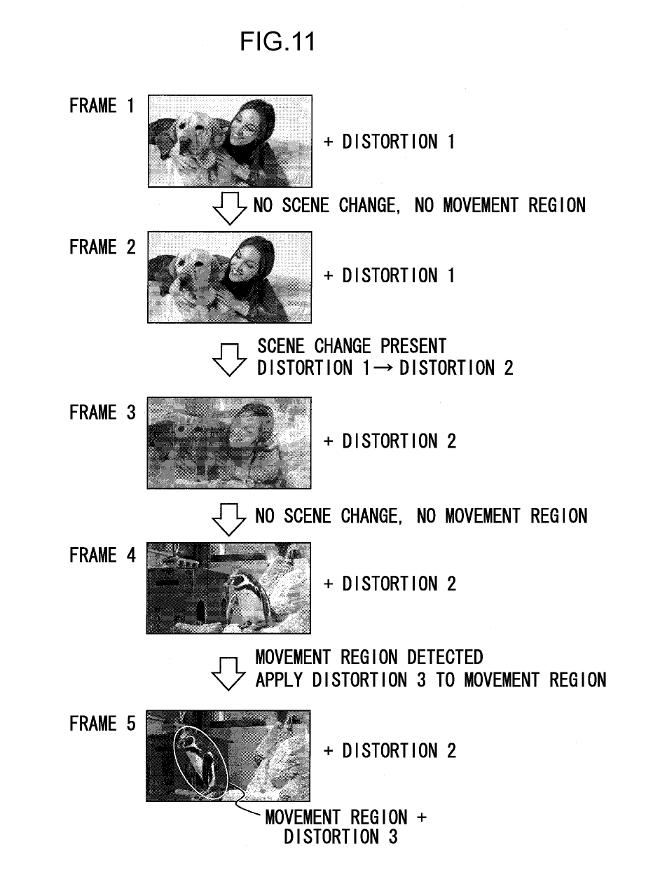

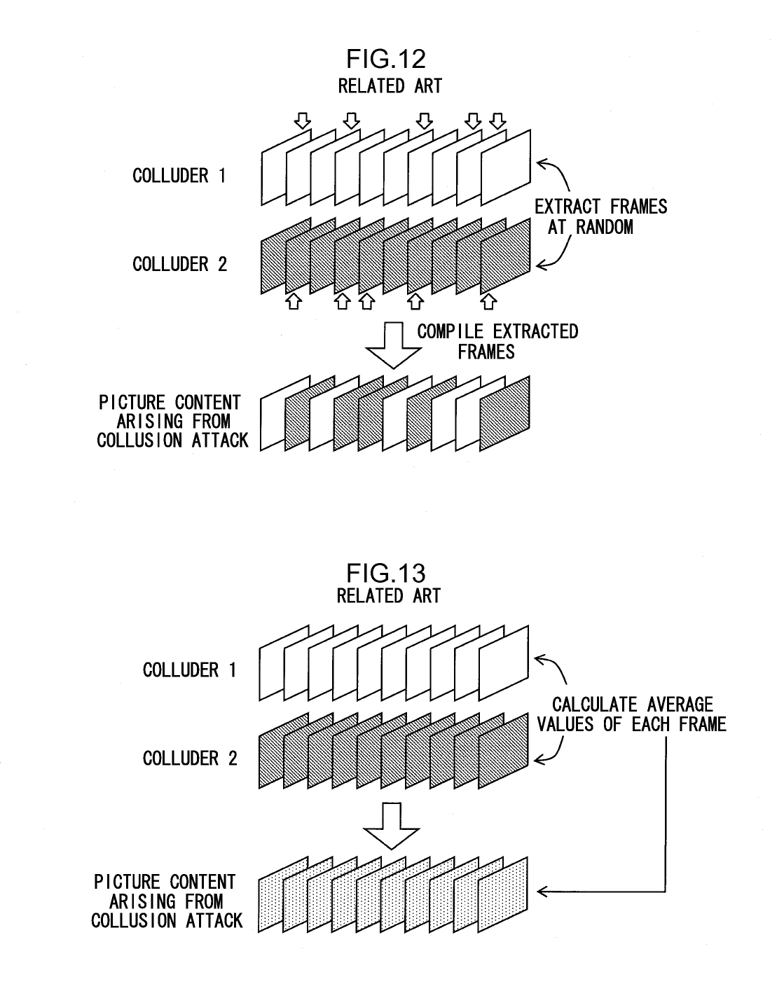

Explanation follows regarding an example of image processing of the third exemplary embodiment, with reference to FIG. 11. The example in FIG. 11 illustrates frames (frame 1 to frame 5) of a section of video image data. There is a scene change present between frame 2 and frame 3, and there is no scene change present between the other frames. There is no movement region present in frame 1 to frame 4, but there is a movement region present in frame 5 (the portion encircled by an ellipse in frame 5).

First a distortion 1 is applied to each of the frames in the video image data by the base distortion processing section 12. Then processing of the frame subject to processing is progressed to the top frame (frame 1), and from there the frame subject to processing transitions straight through to frame 3, since there is no scene change or movement region present in frame 1 or frame 2. In frame 3, since a scene change is detected, the type of distortion processing is changed from the distortion 1 applied by the base distortion processing section 12 to the distortion 2. The distortion 2 is applied to the frame 3 then frame subject to processing transitions to the next frame 4. Since there is no scene change or movement region present in frame 4, the distortion 2 that is the same distortion processing that was applied in the previous frame, frame 3, is applied, and then the frame subject to processing transitions to the next frame 5. In frame 5, since a movement region is detected, in addition to the distortion 2 applied to the overall frame, a distortion 3 is also applied to the movement region.

According to the image processing apparatus 310 of the third exemplary embodiment as explained above, a different type of distortion processing is applied to the movement region to the type of distortion processing that is applied to the frame as a whole. It is accordingly possible to deteriorate the picture quality generated by collusion attack in a more complex manner without imparting an unnatural sensation to the normal viewer.

Note that in the third exemplary embodiment, although explanation has been given of a case in which distortion processing is applied to all movement regions detected in the video image data, configuration may be made such that distortion processing is applied to a specific number of movement regions selected from out of detected movement regions.

Moreover, in the third exemplary embodiment, although explanation has been given of a case in which distortion processing is first applied to all frames by the base distortion processing section, scene changes are detected for and distortion processing is changed for each scene change, and then movement regions are detected for and distortion processing is applied thereto, there is no limitation thereto. For example, scene changes and movement regions may be detected for first. Then, processing may be performed by transitioning the frame subject to processing in sequence from the first frame, changing the distortion processing for the frame image as a whole or applying distortion processing to the movement region upon reaching a frame in which a scene change or movement region is detected.

Moreover, in the third exemplary embodiment, although explanation has been given of an embodiment in which processing to apply distortion processing to movement regions has been added to the second exemplary embodiment, an embodiment may be configured in which processing to apply distortion processing to movement regions is added to the first exemplary embodiment. In such cases, additional image processing of the processing illustrated in FIG. 10 may be executed between step 108 and step 110 in the first image processing of the exemplary embodiment (FIG. 4).

Moreover, although explanation has been given of cases in the first to the third exemplary embodiment in which the user ID is employed during selection of the type of distortion processing, there is no limitation to the user ID, and any suitable data may be employed such that a different type of distortion processing is selected for each person to whom the picture content is provided. For example, data such as a serial number uniquely allocated to the picture content itself and associated with the user ID may be employed, or a room number may be employed for a service in which picture content is distributed to each room such as in a hotel.

Moreover, although explanation has been given of cases in the first to the third exemplary embodiment in which plural types of distortion processing are stored in an internal distortion processing storage section, configuration may be made in which the distortion processing is read from distortion processing stored in a storage region in an external device.

Moreover, explanation has been given of cases in the first to the third exemplary embodiment in which an image processing apparatus is implemented by executing a program stored on a computer. The computer applied in such a case may be a personal computer (PC) or a device such as a server.

The image processing apparatus of technology disclosed herein may be implemented as a terminal on the receiving side (user side) that is provided with the picture content, or may be implemented by a terminal on the transmission side that provides the picture content.

In cases in which the technology disclosed herein is provided on the receiving side, the image processing program of technology disclosed herein may be implemented by installation on for example a user PC. In such cases, picture content downloaded such as through the Internet may be applied with distortion processing by executing the image processing program of technology disclosed herein, and then displayed on a display. Note that restriction may be provided in a computer not stored with the image processing program of technology disclosed herein such that picture content cannot be output (displayed). Alternatively, the image processing apparatus of the technology disclosed herein may be implemented by a dedicated terminal such as a set top box.

When the technology disclosed herein is implemented on the transmission side, when a request for picture content transmission is received from a user, transmission may be made after first applying the distortion processing based on the user ID to the picture content desired by the user. Moreover, when picture content is distributed recorded on a recording medium such as a DVD or Blu-ray disk (BD) video image data may be recorded on the DVD or BD after image processing of the technology disclosed herein has been performed.

Moreover, explanation has been given of embodiments in which the image processing programs 50, 250, 350, that are examples of image processing program of technology disclosed herein, are pre-stored (installed) on the storage section 36. However, it is possible to supply the image processing program of the technology disclosed herein recorded on a recording medium, such as a CD-ROM or a DVD-ROM.

An aspect of the technology disclosed herein, has the advantageous effect of enabling suppression of unauthorized distribution of picture content generated by collusion attack by deteriorating the quality of picture content generated by collusion attack.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An image processing apparatus, comprising:
a processor; and
a memory storing instructions, which, when executed by the processor, perform a procedure, the procedure including:
(a) applying distortion processing to each frame of the whole of or a section of video image data that contains a plurality of successive frames and that is provided to a plurality of users, the distortion processing being selected from amongst a plurality of types of distortion processing such that a different distortion processing is applied for each of the users.

2. The image processing apparatus of claim 1, further comprising:
(b) detecting, as a scene change, instances in which an inter-frame change in an image characteristic amount based on pixel values of each frame is a predetermined threshold value or greater; and
(c) applying a different distortion processing for each of the users, to frames prior to the scene change detected by (b), or to frames after the scene change, or to frames both prior to and after the scene change, such that the distortion processing differs between the frames prior to the scene change and the frames after the scene change.

3. The image processing apparatus of claim 1, further comprising:
(d) detecting, as a movement region, a region in which a moving object is present in each frame; and
(e) applying distortion processing to the movement region detected by (d), the distortion processing being different for each of the users and being different from distortion processing that is applied to regions other than the movement region.

4. The image processing apparatus of claim 1, wherein
the plurality of types of distortion processing includes at least one processing selected from the group consisting of processing to enlarge an image of each frame, processing to rotate an image of each frame, processing to change one or more characteristics out of brightness, hue and saturation of pixels in each frame, and processing to transform the position of each of the pixels according to a predetermined rule.

5. The image processing apparatus of claim 1, wherein:
data for identifying the user is embedded as a digital watermark in the video image data.

6. An image processing method to be executed by a processor, comprising:
(a) applying distortion processing to each frame of the whole of or a section of video image data that contains a plurality of successive frames and that is provided to a plurality of users, the distortion processing being selected from amongst a plurality of types of distortion processing such that a different distortion processing is applied for each of the users.

7. The image processing method to be executed by a processor of claim 6, further comprising:
(b) detecting, as a scene change, instances in which an inter-frame change in an image characteristic amount based on pixel values of each frame is a predetermined threshold value or greater; and
(c) applying a different distortion processing for each of the users, to frames prior to the scene change detected by (b), or to frames after the scene change, or to frames both prior to and after the scene change, such that the distortion processing differs between the frames prior to the scene change and the frames after the scene change.

8. The image processing method to be executed by a processor of claim 6, further comprising:
(d) detecting, as a movement region, a region in which a moving object is present in each frame; and
(e) applying distortion processing to the movement region detected by (d), the distortion processing being different for each of the users and being different from distortion processing that is applied to regions other than the movement region.

9. The image processing method to be executed by a processor of claim 6, wherein
the plurality of types of distortion processing includes at least one processing selected from the group consisting of processing to enlarge an image of each frame, processing to rotate an image of each frame, processing to change one or more characteristics out of brightness, hue and saturation of pixels in each frame, and processing to transform the position of each of the pixels according to a predetermined rule.

10. The image processing method to be executed by a processor of claim 6, wherein:
data for identifying the user is embedded as a digital watermark in the video image data.

11. A computer-readable recording medium having stored therein a program for causing a computer to execute an image processing process comprising:
(a) applying distortion processing to each frame of the whole of or a section of video image data that contains a plurality of successive frames and that is provided to a plurality of users, the distortion processing being selected from amongst a plurality of types of distortion processing such that a different distortion processing is applied for each of the users.

12. The computer-readable recording medium of claim 11, the image processing process further comprising:
(b) detecting, as a scene change, instances in which an inter-frame change in an image characteristic amount based on pixel values of each frame is a predetermined threshold value or greater; and
(c) applying a different distortion processing for each of the users to frames prior to the scene change detected by (b), or to frames after the scene change, or to frames both prior to and after the scene change, such that the distortion processing differs between the frames prior to the scene change and the frames after the scene change.

13. The computer-readable recording medium of claim 11, the image processing process further comprising:
(d) detecting, as a movement region, a region in which a moving object is present in each frame; and
(e) applying distortion processing to the movement region detected by (d), the distortion processing being different for each of the users and being different from distortion processing that is applied to regions other than the movement region.

14. The computer-readable recording medium of claim 11, wherein:
the plurality of types of distortion processing includes at least one processing selected from the group consisting of processing to enlarge an image of each frame, processing to rotate an image of each frame, processing to change one or more characteristics out of brightness, hue and saturation of pixels in each frame, and processing to transform the position of each of the pixels according to a predetermined rule.

15. The computer-readable recording medium of claim 11, wherein:
data for identifying the user is embedded as a digital watermark in the video image data.
